(19) United States
(12) Patent Application Publication
(10) Pub. No.: US 2026/0320944 A1
(43) Pub. Date: Oct. 15, 2026

(54) PERSONALIZED VIRTUAL LAYOUT FOR COLLABORATIVE METAVERSE SESSIONS

(71) Applicant: International Business Machines Corporation, Armonk, NY (US)

(72) Inventors: Heather Nicole POLGREAN, Lagrangeville, NY (US); Hamid MAJDABADI, Ottawa (CA); Sarbajit Kumar RAKSHIT, Kolkata (IN); Carolina GARCIA DELGADO, Zapopan (MX)

(21) Appl. No.: 19/174,158

(22) Filed: Apr. 9, 2025

(51) Int. Cl. G06T 19/20

(52) U.S. Cl. CPC G06T 19/20; G06T 2219/20

(57) ABSTRACT

In some implementations, a computer may obtain sensing information indicating real-time information associated with a physical space of a user. The computer may obtain a participant profile of the user, where the participant profile indicates at least one of a role, a responsibility, or a mobility type of the user for a metaverse collaboration session. The computer may generate, using a generative model, a personalized virtual layout within the metaverse collaboration session based on the sensing information and the participant profile, where generating the personalized virtual layout includes arranging one or more virtual objects in the personalized virtual layout based on one or more constraints indicated by at least one of the sensing information or the participant profile. The computer may provide, for display in association with the metaverse collaboration session, the personalized virtual layout.

### BACKGROUND

This disclosure relates to virtual worlds, and more specifically, to personalized virtual layout for collaborative metaverse sessions.

### SUMMARY

Some aspects described herein relate to a method. The method may include obtaining sensing information indicating real-time information associated with a physical space of a user. The method may include obtaining a participant profile of the user, where the participant profile indicates at least one of a role, a responsibility, or a mobility type of the user for a metaverse collaboration session. The method may include generating, using a generative model, a personalized virtual layout within the metaverse collaboration session based on the sensing information and the participant profile, where generating the personalized virtual layout includes arranging one or more virtual objects in the personalized virtual layout based on one or more constraints indicated by at least one of the sensing information or the participant profile. The method may include providing, for display in association with the metaverse collaboration session, the personalized virtual layout.

Some aspects described herein relate to a computer system. The computer system may include a processor set, one or more computer-readable storage media, and program instructions stored on the one or more computer-readable storage media to cause the processor set to perform operations. The operations may include obtaining sensing information indicating real-time information associated with a physical space of a user. The operations may include obtaining a participant profile of the user, where the participant profile indicates at least one of a role, a responsibility, or a mobility type of the user for a metaverse collaboration session. The operations may include generating, using a generative model, a personalized virtual layout within the metaverse collaboration session based on the sensing information and the participant profile, where the personalized virtual layout includes one or more virtual objects that are configured based on one or more constraints indicated by at least one of the sensing information or the participant profile. The operations may include providing, for display in association with the metaverse collaboration session, the personalized virtual layout.

Some aspects described herein relate to a computer program product. The computer program product may include one or more computer-readable storage media and program instructions stored on the one or more computer-readable storage media to perform operations. The operations may include obtaining sensing information indicating real-time information associated with a physical space of a user. The operations may include obtaining a participant profile of the user, where the participant profile indicates at least one of a role, a responsibility, or a mobility type of the user for a metaverse collaboration session. The operations may include generating, using a generative model, a personalized virtual layout within the metaverse collaboration session based on the sensing information and the participant profile. The operations may include arranging, using the generative model, one or more virtual objects within the personalized virtual layout to accommodate real-time movements of the user. The operations may include providing, for display in association with the metaverse collaboration session, the personalized virtual layout.

### BRIEF DESCRIPTION OF THE DRAWINGS

FIG. 1 is a diagram of an example computing environment for a personalized virtual layout for collaborative metaverse sessions described herein.

FIGS. 2A-2C are diagrams of an example associated with a personalized virtual layout for collaborative metaverse sessions.

FIG. 3 is a diagram of example components of a device associated with a personalized virtual layout for collaborative metaverse sessions.

FIG. 4 is a flowchart of an example process associated with a personalized virtual layout for collaborative metaverse sessions.

### DETAILED DESCRIPTION

The following detailed description of example implementations refers to the accompanying drawings. The same reference numbers in different drawings may identify the same or similar elements.

Virtual worlds, such as the metaverse, are digital environments that simulate real-world experiences or create new ones. The metaverse is a collective virtual shared space, created by the convergence of virtual reality (VR), augmented reality (AR), the internet, and other technologies. A metaverse environment allows users to interact with each other and digital objects in real time, and is used for various purposes, such as social interaction, entertainment, education, and/or collaboration.

Virtual collaboration involves participants from different physical locations with varying spatial constraints and conditions interacting in a session (e.g., a metaverse collaboration session) in a metaverse environment. However, while participating in a metaverse collaboration session, there is a lack of synchronization between the virtual world and the real world. Current metaverse platforms have difficulties adapting virtual collaborative spaces to physical differences due to the complexity of processing multiple sources of data, such as spatial data, biometric data, and role-based permissions. The diversity of devices and interfaces used by participants in a metaverse collaboration session, such as VR headsets, AR glasses, and desktop computers, also complicates the task of creating a virtual environment. For example, accommodating the varying physical spaces of participants in a metaverse collaboration session may be difficult. As an example, participants may be joining from different physical locations with distinct spatial constraints, such as a home office, a conference room, or a coffee shop. Each location may have its own unique layout, obstacles, and/or limitations, which can affect the participant's ability to interact with the virtual environment. For example, a participant joining from a small home office may have limited space to move around, while a participant joining from a conference room may have more freedom to roam.

Additionally, interactions within a metaverse collaboration session may vary based on role of respective participants. For example, in some metaverse collaboration sessions, there may be a speaker and one or more listeners. In such examples, an avatar of the speaker in the metaverse collaboration session may need be positioned such that the one or more listeners can view and/or hear the speaker in the metaverse collaboration session. However, the listeners' avatars may not need to be positioned in a specific way relative to each other, as long as they can all see and hear the speaker. This can create a challenge in terms of spatial reasoning, collision detection, and audio propagation, as a metaverse system may need to take into account the physical spaces of all participants and adapt the avatar placement accordingly.

Additionally, the system must also account for the varying devices and interfaces used by participants, such as VR headsets, AR glasses, and desktop computers. Each device may have its own unique capabilities and limitations, which can affect the participant's ability to interact with the virtual environment. For example, a participant using a VR headset may be able to move around freely and interact with virtual objects in a more immersive way, while a participant using a desktop computer may be limited to interacting with virtual objects using a mouse and keyboard.

These challenges can be further complicated by the need to accommodate different roles and responsibilities within the metaverse collaboration session. For example, a moderator may need to have more control over the virtual environment than a listener, and the metaverse system must be able to adapt to these different roles and responsibilities in real-time. The system must also be able to handle conflicts and inconsistencies that may arise from the varying physical spaces and devices used by participants, such as when two participants try to occupy the same virtual space or when a participant's device is unable to render a virtual object correctly.

As a result, a virtual layout for a metaverse collaboration session may be a standardized layout that does not take constraints of physical spaces or roles of participants into account. This may limit the useability or effectiveness of the metaverse collaboration session. For example, the virtual layout for the metaverse collaboration session may include one or more virtual objects that an avatar of a given participant is unable to reach or otherwise interact with in the metaverse collaboration session due to the physical space or other physical constraints of the given participant. As another example, the virtual layout for the metaverse collaboration session may include one or more virtual objects that are arranged in a manner that limit the effectiveness of collaboration based on roles of respective participants (e.g., an avatar of a speaker may be positioned such that the avatar cannot be viewed by all participants). This may consume network resources, processing resources, and/or memory resources, among other examples, associated with generating and providing (e.g., for display) the virtual layout for the metaverse collaboration session that is inefficient or ineffective for the metaverse collaboration session. Additionally, this can lead to user discomfort, distraction, and/or reduced productivity.

Some implementations described herein enable personalized virtual layouts within a metaverse collaboration session. In some examples, a computer (e.g., a metaverse server) may uses a generative model to dynamically create a personalized virtual layout for a metaverse collaboration session, taking into account the physical space and technical requirements of each user, as well as the role and responsibilities of each user, to optimize the allocation of computational resources and improve the effectiveness of the collaboration. For example, the computer may obtain sensing information indicating real-time information associated with a physical space of a user participating in the metaverse collaboration session. The computer may obtain a participant profile of the user. The participant profile indicates a role, a responsibility, and/or a mobility type of the user for the metaverse collaboration session. The computer may generate, using a generative model, a personalized virtual layout within the metaverse collaboration session based on the sensing information and the participant profile. In some aspects, the computer may arrange one or more virtual objects in the personalized virtual layout based on one or more constraints indicated by the sensing information and/or the participant profile.

For example, a speaker may be participating in a metaverse collaboration session with a group of listeners to discuss a topic. The speaker may be joining the session from a small office, which has a limited amount of physical space, while the listeners are joining from a large conference room with ample space to move around. The computer may obtain sensing information from the speaker's device (such as a VR headset), which indicates that they have limited mobility and a restricted field of view due to the physical constraints of their office. The computer may obtain the participant profile of the speaker, which indicates that the speaker is the primary presenter of the metaverse collaboration session and need to be able to see and interact with all of the virtual objects in the session. Based on this information, the computer may use a generative model to create a personalized virtual layout for the speaker, which arranges the virtual objects in a way that allows them to easily see and interact with them despite the physical limitations of the physical space of the speaker. Meanwhile, the listeners in the conference room are given a different virtual layout that takes advantage of their available physical space, allowing the listeners to move around and interact with the virtual objects in a more immersive way. This enables the group to collaborate more effectively, with the speaker able to present and the listeners able to provide input and feedback in a more engaging and interactive way.

As a result, the computer may improve the usability and effectiveness of the metaverse collaboration session by ensuring that each participant can interact with virtual objects in a way that is tailored to their physical space and role, thereby reducing user discomfort, distraction, and improving productivity. The computer may also optimize the placement of avatars and virtual objects based on the roles and responsibilities of participants, ensuring that each participant can see and interact with the virtual objects that are relevant to their role, thereby improving collaboration and reducing misunderstandings. In some examples, the computer may optimize the allocation of computational resources, such as processing power and memory, by dynamically generating a virtual layout that adapts to the physical and technical requirements of each user. The computer may reduce network latency and improves data transmission efficiency by using a generative model to create a personalized virtual layout that minimizes the amount of data required to render the virtual layout.

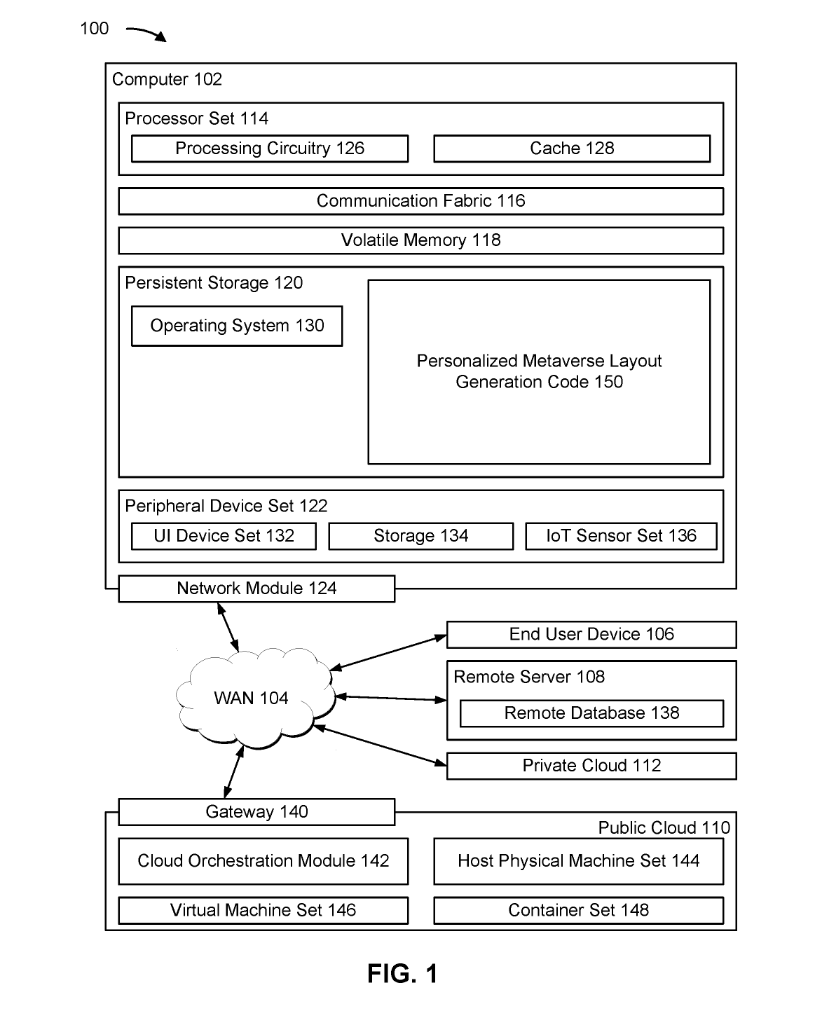

FIG. 1 is a diagram of an example computing environment 100 for a personalized virtual layout for collaborative metaverse sessions described herein.

The computing environment 100 contains an example of an environment for the execution of at least some of the computer code involved in performing the inventive methods, such as personalized metaverse layout generation code 150. In addition to the personalized metaverse layout generation code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the personalized metaverse layout generation code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in personalized metaverse layout generation code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input / output ports, among other examples. Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The code included in the personalized metaverse layout generation code 150 typically includes at least some of the computer code involved in performing one or more operations described herein. In some implementations, the operations may include obtaining sensing information indicating real-time information associated with a physical space of a user. In some implementations, the operations may include obtaining a participant profile of the user, where the participant profile indicates at least one of a role, a responsibility, or a mobility type of the user for a metaverse collaboration session. In some implementations, the operations may include generating, using a generative model, a personalized virtual layout within the metaverse collaboration session based on the sensing information and the participant profile, where generating the personalized virtual layout includes arranging one or more virtual objects in the personalized virtual layout based on one or more constraints indicated by at least one of the sensing information or the participant profile. In some implementations, the operations may include providing, for display in association with the metaverse collaboration session, the personalized virtual layout.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1 is provided as an example. Other examples may differ from what is described with regard to FIG. 1.

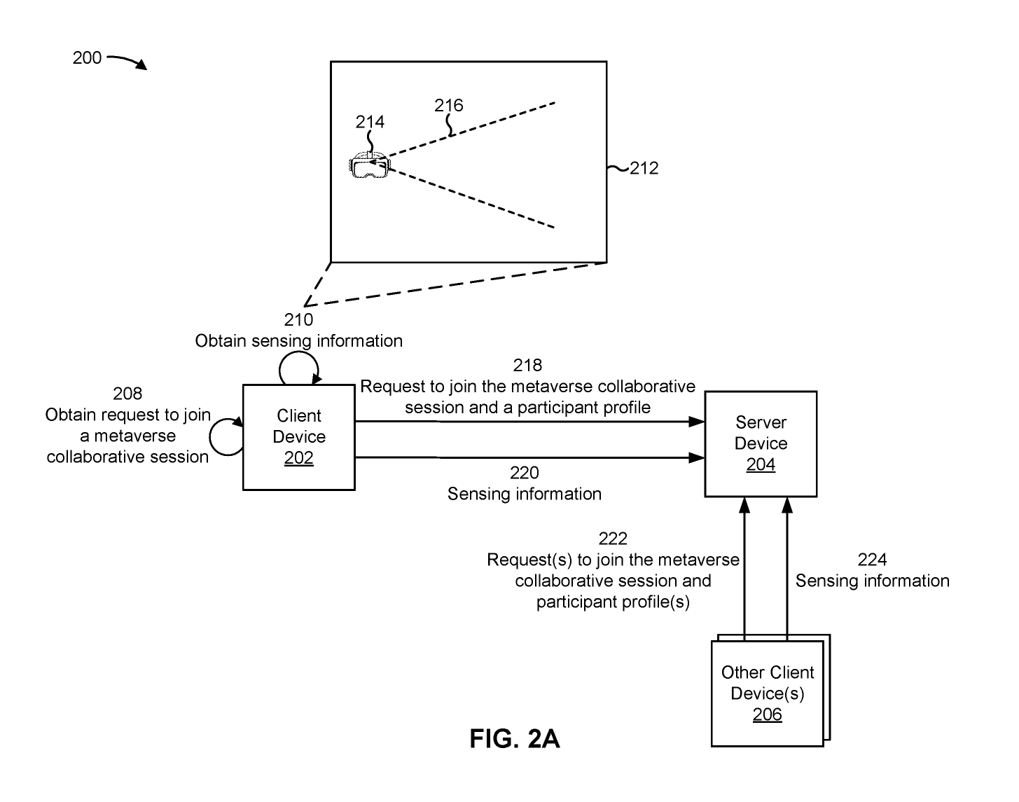

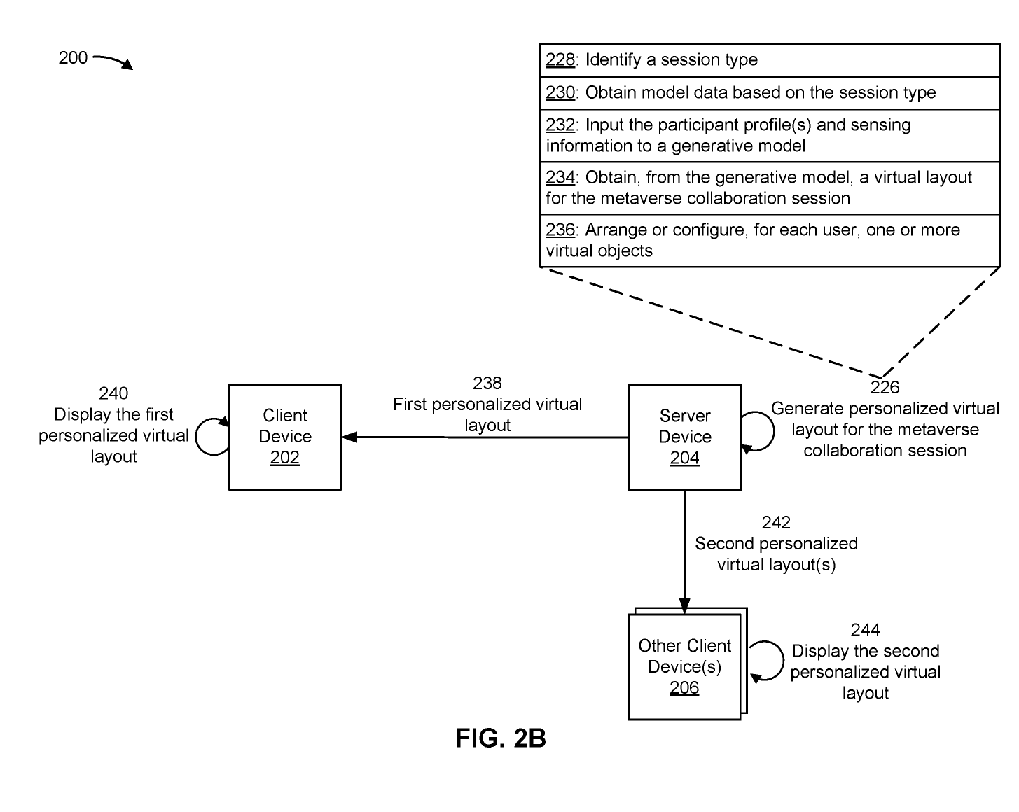

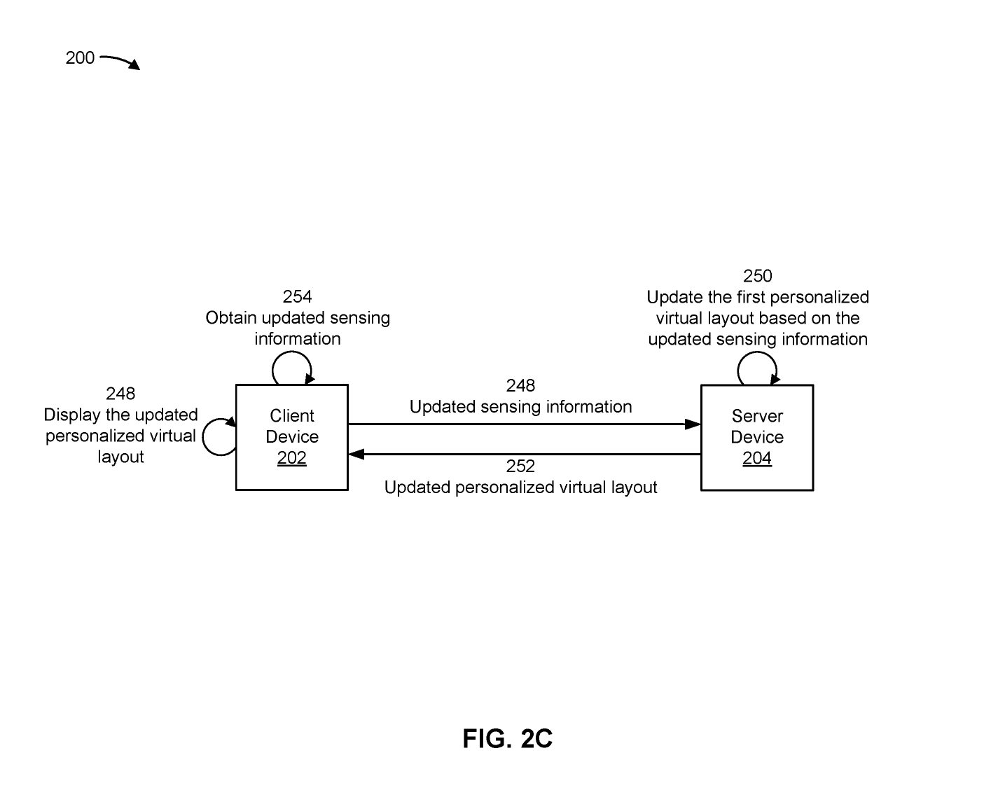

FIGS. 2A-2C are diagrams of an example 200 associated with a personalized virtual layout for collaborative metaverse sessions. As shown in FIGS. 2A-2C, example 200 includes a server device 202 (e.g., a first computer 102) and a client device 204 (e.g., a second computer 102).

The server device 202 may be, or may include, a metaverse server. A metaverse server may be configured to host, manage, and/or facilitate metaverse collaboration sessions, such as generating and adapting personalized virtual layouts described herein. Additionally, the metaverse server may process user input, and/or synchronize interactions among multiple users in real-time, among other examples. Additionally, the metaverse server may perform user authentication, perform data storage for a metaverse environment or session, and/or generate, render, and/or arrange virtual objects and environments, among other examples. The client device 204 may be, or may include, a metaverse client. A metaverse client may be configured to render and/or display personalized virtual layouts received from a metaverse server (e.g., the server device 202), as described herein. Additionally, the metaverse client may capture and transmit user input, such as movements and interactions, to the server device 202 for processing. The metaverse client may perform local rendering of virtual objects, process sensory data, and/or provide real-time feedback to a user, among other examples.

In some examples, the client device 204 (or other client devices 206 shown in FIG. 2A and 2B) may include one or more peripheral devices (such as from the peripheral device set 122) that enable users to interact with virtual objects and other users in a metaverse collaboration session. For example, the client device 204 may be, or may include, a wearable device, such as a VR device or an AR device. For example, the one or more peripheral devices may include sensors and tracking systems that monitor head movements, hand gestures, and/or other physical interactions, allowing the client device 204 to accurately render the virtual environment and objects in real-time. This enables a user to manipulate virtual objects, navigate through virtual spaces, and/or interact with other users in a metaverse environment. For example, the client device 204 may include a VR headset worn by a user. The user may use hand controllers or gestures to manipulate virtual objects in a metaverse environment, such as picking up a virtual pen to write on a virtual whiteboard or moving a virtual chair to reconfigure a virtual meeting space. Similarly, a user wearing an AR device may use gestures or voice commands to interact with virtual objects overlaid on the real-world environment, such as selecting a virtual button to activate a virtual display or using a virtual pointer to highlight a specific area of a shared document.

In addition to wearable devices, other peripheral devices. such as 3D mice, haptic feedback devices, or biometric sensors may also be used for interaction in a metaverse collaboration session. For example, a 3D mouse may allow users to precisely navigate through virtual spaces and manipulate virtual objects with greater precision, while a haptic feedback device may provide tactile feedback to users, simulating the sensation of touch or texture in the virtual environment. Biometric sensors, such as heart rate or skin conductance sensors, may also be used to monitor physiological responses and adapt the virtual environment accordingly. For example, if a user's heart rate increases, the system may adjust the virtual environment to reduce stress or anxiety, such as by changing the lighting or color scheme, as described in more detail elsewhere herein.

As shown in FIG. 2A, and by reference number 208, the client device 204 may obtain a request to join a metaverse collaboration session. For example, a user may provide an input (such as to a user interface) that indicates that the user wishes to join the metaverse collaboration session. For example, the user may interact with a user interface on the client device 204, such as a touchscreen or a keyboard, to indicate their desire to join the session. In some examples, the client device 204 may receive an invitation to join the metaverse collaboration session from another client device 206 or from the server device 202. For example, a user may receive an email or a message with a link to join the session, or they may receive a notification on the client device 204 with an option to join the metaverse collaboration session (e.g., and the request to join the metaverse collaboration session may include the user selecting the link or selecting the option to join the metaverse collaboration session).

As shown by reference number 210, the client device 204 may obtain sensing information based on obtaining the request to join the metaverse collaboration session. In some examples, the sensing information may be associated with a physical space 212. The physical space 212 may be a physical area around a user of the client device 204. By the client device 204 obtaining the sensing information based on obtaining the request to join the metaverse collaboration session, the client device 204 may obtain sensing information that is indicative of properties or characteristics of the physical space 212 near a time when the user is joining the metaverse collaboration session. In some examples, the client device 204 may obtain the sensing information via a peripheral device 214. The peripheral device 214 may be a wearable device (such as a VR headset, goggles, or smart jewelry (e.g., a smart watch)), a sensing device, a biometric sensing device, or another device capable of obtaining sensing information. For example, the peripheral device 214 may include one or more sensors, one or more cameras, and/or one or more other devices configured to capture or otherwise obtain the sensing information. For instance, a VR headset may include one or more cameras and sensors that can obtain depth-sensing data of the physical space 212, while a smart watch may include one or more biometric sensors that track a heart rate and other physiological signals of the user.

The sensing information may be real-time information. In the context of sensing information, real-time information refers to data that is collected and processed at a rate that is contemporaneous with the physical phenomenon being sense (e.g., with a latency that satisfies a threshold, such as a few milliseconds to tens of milliseconds, depending on the specific application and requirements). In other words, the sensing information described herein may be streamed continuously from the one or more sensors or peripheral devices to the client device 204, where it is analyzed and interpreted in near-instantaneous fashion, allowing for prompt feedback and adaptation to changing conditions in the physical space 212 or in biometric changes for the user.

In some examples, as shown by reference number 216, the sensing information may include depth-sensing information or spatial information of the physical space 212. The depth-sensing information or spatial information may include information that quantitatively describes the physical space 212 and/or a layout or location of one or more objects, surfaces, or features within the physical space 212. The depth-sensing information or spatial information can be used to create a 3D model of the physical space 212. For example, if the user is in a room with a desk and chair, the depth-sensing information can be used to create a virtual replica of the room, complete with virtual versions of the desk and chair. In some examples, the depth-sensing information or spatial information may include 3D coordinates (x, y, z) of objects and surfaces, distance and orientation metrics between objects, and/or detailed shape and size descriptors of objects and surfaces (such as polygon meshes or nodal points), among other examples. Additional, depth-sensing information or spatial information may include topological relationships between objects and surfaces, such as adjacency matrices, connectivity graphs, and/or texture and reflectivity attributes of surfaces, among other examples. The client device 204 may obtain the depth-sensing information or spatial information through various methods, such as depth sensing, light detection and ranging (LiDAR), stereo vision, and/or structured light scanning, among other examples. The depth-sensing information or spatial information can be represented in a variety of formats, such as one or more visual images, 3D mesh models, point clouds, and/or spatial graphs, among other examples.

In some examples, the sensing information may include an indication of one or more objects located in the physical space. For example, the client device 204 may perform an object recognition operation based on sensing information to detect, identify and/or categorize one or more objects. For example, the client device 204 may use one or more computer vision algorithms and/or machine learning models that analyze the depth-sensing information or spatial information captured by the peripheral device 214. For example, the client device 204 may use a convolutional neural networks (CNNs) and/or deep learning-based object detection architectures, among other examples to process the visual data and identify objects within the physical space 212. The object recognition information can include object labels, coordinates, dimensions, orientation, and/or other properties.

In some examples, the sensing information may include ergonomic information for the user. The ergonomic information may refer to data that describes the physical relationship between the user and their environment (such as the physical space 212), specifically in terms of comfort, efficiency, and safety. The ergonomic information may include one or more metrics, such as a posture, a pose, body orientation, arm reach, user height, and/or one or more movement patterns, among other examples. The ergonomic information may include a user pose and orientation (e.g., including whether they are sitting, standing, or lying down), one or more body part positions and angles (such as shoulder, elbow, and wrist angles), one or more movement patterns and trajectories (e.g., including speed, acceleration, and/or jerk), and/or one or more environmental factors (such as lighting levels, temperature, and air quality), among other examples. In some examples, the client device 204 may obtain the ergonomic information based on a user input, such as to a user interface associated with establishing or joining the metaverse collaboration session.

In some examples, the client device 204 may determine an available movement space for the user based on the sensing information. For example, the client device 204 may analyze the spatial information or depth-sensing information captured by the peripheral device 214. In some examples, the client device 204 may use computer vision and/or machine learning algorithms to process visual data and/or the spatial information or depth-sensing information to identify one or more boundaries and obstacles within the physical space 212. The client device 204 may create a 3D map of the physical space 212 based on the analysis of the spatial information or depth-sensing information. The client device 204 may determine the available movement space based on the 3D map. For example, the client device 204 can detect the location and orientation of furniture, walls, and other obstacles, and use this information to define a safe and navigable area within the physical space 212.

In some examples, the client device 204 may determine the available movement space by applying one or more algorithms and techniques to the 3D map, such as ray casting, sphere casting, and/or other collision detection methods. These algorithms can simulate the movement of the user within the space, and detect any potential collisions or obstructions. The client device 204 can then use this information to define a suitable movement space, taking into account factors such as the user’s size, shape, movement capabilities, and/or other information indicated by the ergonomic information. In some examples, the available movement space can be represented as a 3D volume or a set of 3D coordinates. The available movement space may indicate available spaces, such as open floors, hand movement available space, obstacle-free areas, and/or other navigable zones within the physical space 212. This enables the server device 202 to generate a personalized virtual layout of the metaverse collaboration session in which the user will be able to navigate to, move with, or otherwise interact with one or more virtual objects without the risk of collision with a physical object in the physical space 212.

In some examples, the sensing information may include biometric information for the user. The biometric information refers to data that describes the physiological and behavioral characteristics of a user, such as heart rate, skin conductance, facial expressions, and/or other bodily responses. The client device 204 may obtain the biometric information via electrodermal activity (EDA) sensors, photoplethysmography (PPG) sensors, facial expression analysis (e.g., the client device 204 may use computer vision and/or machine learning to analyze facial movements and emotions), and/or physiological signal processing (e.g., the client device 204 may extract relevant features from physiological signals, such as heart rate, blood pressure, and skin temperature), among other examples. The biometric information may include a heart rate, a heart rate variability (HRV), a skin conductance, a skin temperature, a facial expression or emotional state, a blood oxygenation, a blood pressure, and/or other physiological signals (such as electroencephalography (EEG) signal or electromyography (EMG) signals).

For example, the client device 204 may use a PPG sensor to measure the heart rate and HRV of the user, which can be used to infer a level of stress, fatigue, and/or engagement, among other examples, of the user. As another example, the client device 204 may detect an emotional state or a mental state of the user (such as happiness, sadness, or frustration) using facial expression analysis. The biometric information may enable the server device 202 to create a more personalized and adaptive virtual environment that responds to the user's physiological and emotional needs, as described in more detail elsewhere herein.

In some examples, the client device 204 may obtain the biometric information via a wearable device (such as a smart watch, a smart ring, or a fitness tracking device), a sensor included in the client device 204 (.g., a camera or microphone), or an external sensor (e.g., an EEG sensor or an EMG sensor). In some examples, the client device 204 may communicate with a device (such as a remote server 108) that is configured to manage and/or store biometric data obtained via a wearable device or an external sensor. The client device 204 may receive the biometric information from the device (such as a remote server 108), such as via an API.

In some examples, the biometric information and/or the ergonomic information may indicate one or more ergonomic parameters for the user. In some examples, the one or more ergonomic parameters may indicate an ergonomic position for the user. The ergonomic position may be an optimal or preferred ergonomic position for the user. The one or more ergonomic parameters may include a height, weight, body proportions, movement patterns, heart rate, HRV, and/or stress level, among other examples. The one or more ergonomic parameters can be used by the server device 202 to identify potential ergonomic risks or discomforts for the user when interacting in the metaverse collaboration session, such as poor posture, eye strain, or repetitive strain injuries, and to adjust the personalized virtual layout for the user accordingly.

As shown by reference number 218, the client device 204 may transmit, and the service device may receive, a request to join the metaverse collaboration session. In some examples, the request to join the metaverse collaboration session may indicate or include a participant profile for the user. The participant profile may indicate a role, a responsibility, or a mobility type of the user for a metaverse collaboration session. For example, the participant profile may indicate a specific role or responsibility that the user will assume within the metaverse collaboration session, such as a presenter, moderator, collaborator, listener, or participant, among other examples. Additionally, the participant profile may also specify a mobility type for the user, which can affect how the user interacts with the virtual environment and other users. The client device 204 may obtain the participant profile via user input (such as to a user interface associated with establishing or joining the metaverse collaboration session). Additionally, or alternatively, the client device 204 may obtain the participant profile via memory, such as from a stored participant profile for the user. In some examples, the server device 202 may obtain at least a portion of the participant profile via memory (e.g., rather than from the client device 204), such as from a stored participant profile for the user.

For example, a user with a role of presenter may be granted access to specific virtual tools, virtual object, and/or features that allow them to control the presentation and share content with other users. In contrast, a user with a role of participant may have more limited access to virtual tools and features, but may still be able to interact with the presenter and other users through chat or voice communication. The participant profile may also include other information about the user, such as their name, avatar appearance, and/or communication preferences, among other examples. In some examples, the mobility type may be based on the sensing information and/or the ergonomic information. For example, the mobility type may indicate whether the user is mobile (e.g., can move throughout a space, such as the physical space 212), stationary, sitting, standing, or other mobility types.

As shown by reference number 220, the client device 204 may transmit, and the server device 202 may receive, the sensing information, such as the sensing information described in connection with reference number 210. For example, the client device 204 may transmit, and the server device 202 may receive, a 3D map of the physical space 212, an available movement space for the user within the physical space 212, the ergonomic information, and/or the biometric information, among other examples.

In some examples, the metaverse collaboration session may be associated with multiple users. The multiple users may be associated with (e.g., may be using) respective client devices 204 or 206. In such examples, the server device 202 may receive or obtain participant profiles and sensing information for respective users of the multiple users. For example, as shown by reference number 222, the server device 202 may receive one or more requests to join the metaverse collaboration session and one or more participant profiles from respective client devices 206 (e.g., in a similar manner as described in connection with reference number 218). Additionally, as shown by reference number 224, the server device 202 may receive or obtain sensing information from respective client devices 206 (e.g., in a similar manner as described in connection with reference number 220).

As shown in FIG. 2B, and by reference number 226, the server device 202 may generate a personalized virtual layout (e.g., for the user of the client device 204 described in FIG. 2A) for the metaverse collaboration session. The generation of the personalized virtual layout may include one or more operations described in connection with reference number 228, reference number 230, reference number 232, reference number 234, and/or reference number 236. As used herein, “personalized” virtual layout refers to a virtual layout of a virtual environment that is to be displayed by the client device 204 for the user. A virtual layout refers to the arrangement and organization of virtual objects, avatars, and/or other elements within a virtual environment, such as a metaverse collaboration session. The virtual layout may define the spatial relationships between these elements in the virtual environment, such as positions, orientations, and/or sizes, among other examples.

In some examples, the server device 202 may generate the personalized virtual layout using a generative model. “Generative model” refers to a model that is trained to generate new or synthetic data that that is similar in structure and content to a given dataset. The generative model may include a generative artificial intelligence (AI) model, a generative adversarial network (GAN) model, a variational autoencoder (VAE) model, a transformer-based model, or another generative model. For example, a GAN may include a generator network model that is configured to configured to generate the personalized virtual layout and a discriminator network model is configured to refine the personalized virtual layout.

The generative model may be trained using a training dataset. The training dataset may include historical metaverse layouts, user interaction data, and/or historical participation profiles, among other examples. The training dataset is a collection of data points, where each data point represents a single metaverse layout, along with the corresponding user interaction data and participation profile. The historical metaverse layouts are represented as 3D spatial data, which captures the geometry, texture, and other visual attributes of the layout.

The user interaction data may include information on how users interact with the metaverse layout, such as navigation paths, object manipulations, and/or other forms of engagement. The user interaction data may be collected from various sources, including user logs, sensor data, and/or other forms of telemetry. The user interaction data may be used to inform the generative model about the relationships between different objects and spaces within the metaverse layout, as well as the user's preferences and behavior. The historical participation profiles may include information on the users who have participated in the metaverse sessions, including their roles, responsibilities, and/or mobility types, among other examples. The historical participation profiles may be used to inform the generative model about the different user types and their corresponding needs and preferences.

The generative model may be trained using a combination of supervised and unsupervised learning techniques. The supervised learning component may involve training the generative model on labeled data, where the labels correspond to the different types of metaverse layouts and user interactions. The unsupervised learning component may involve training the generative model on unlabeled data, where the generative model learns to identify patterns and relationships in the data without explicit labels. In some examples, the generative model is trained using a loss function that measures the difference between a predicted metaverse layout and an actual metaverse layout. The loss function may be optimized using an optimization algorithm, such as stochastic gradient descent (SGD), among other examples.

In some examples, the generative model may be associated with one or more model datasets. The one or more model datasets may be associated with respective metaverse collaboration scenarios. The model data may be data to provide context or information for a given metaverse collaboration scenario. By providing the model data to the generative model, the generative model may generate a more accurate output (e.g., a more accurate personalized virtual layout) for a given metaverse collaboration scenario of the metaverse collaboration session (e.g., because the generative model has context for the given metaverse collaboration scenario). The metaverse collaboration scenarios may include different collaboration types in various virtual environments, such as board meetings, brainstorming sessions, design reviews, product reviews, training or education sessions, sales presentations, team meeting, client meeting, product testing, virtual focus groups, creative collaboration sessions, among other examples. The model data may include information on the spatial layout, user interactions, and participation profiles associated with a given metaverse collaboration scenario. For example, a model data point for a board meeting scenario may include the layout of a virtual conference room, the interactions between users (e.g., presentations, discussions), and the participation profiles of the users (e.g., roles, responsibilities). Similarly, a model data point for a brainstorming session scenario might include the layout of a virtual ideation space, the interactions between users (e.g., idea generation, feedback), and the participation profiles of the users (e.g., creative director, designer). The model data may be used to train the generative model to recognize patterns and relationships between different collaboration types, allowing the generative model to generate new metaverse layouts that are tailored to specific collaboration goals and user needs.

As shown by reference number 228, the server device 202 may identify a session type for the metaverse collaboration session. A session type may be associated with, or indicate, a metaverse collaboration scenario. The session type may be indicated by configuration information for the metaverse collaboration session (e.g., a user input may indicate the session type). Additionally, or alternatively, the server device 202 may determine the session type based on participant profiles of respective users who are participating in the metaverse collaboration session. For example, if a group of executives are participating in a metaverse collaboration session, the server device 202 may infer that the session type is a board meeting, based on their roles and responsibilities. Similarly, if a group of designers are participating in a metaverse collaboration session, the server device 202 may infer that the session type is a brainstorming session, based on their job functions and the goals of the session.

Once the session type is identified, the server device 202 can use this information to tailor the virtual environment to the specific needs of the users. For example, if the session type is a board meeting, the server device 202 may create a virtual conference room with a formal layout and restricted access to sensitive information. If the session type is a brainstorming session, the server device 202 may create a virtual ideation space with a more relaxed layout and interactive tools for idea generation. By identifying the session type and tailoring the virtual environment accordingly, the server device 202 can create a more effective and efficient metaverse collaboration session that meets the specific needs and goals of the users.

As shown by reference number 230, the server device 202 may obtain model data based on the session type. For example, the server device 202 may obtain model data corresponding to a given metaverse collaboration scenario that is indicated by the session type. For example, the server device 202 may identify a metaverse collaboration scenario from the metaverse collaboration scenarios based on a session type of the metaverse collaboration session and one or more participant profiles. The server device 202 may generate the personalized virtual layout based on the generative model using model data, from the model dataset, that corresponds to the metaverse collaboration scenario. For example, the server device 202 may identify a metaverse collaboration scenario from the metaverse collaboration scenarios based on a session type of the metaverse collaboration session and one or more participant profiles. This may involve analyzing the session type and participant profiles to determine the most relevant metaverse collaboration scenario, and then retrieving the corresponding model data from a model dataset.

The server device 202 may generate the personalized virtual layout based on the generative model using the model data that corresponds to the metaverse collaboration scenario. This may involve using the generative model to create a virtual environment that is tailored to the specific needs and goals of the users, and that incorporates the features and tools that are relevant to the metaverse collaboration scenario. For example, the server device 202 may provide the model data to the generative model to be used as context by the generative model. By using model data that corresponds to a specific metaverse collaboration scenario, the server device 202 can generate a personalized virtual layout that is tailored to the specific needs and goals of the users, and that provides a more effective and efficient collaboration experience.

As shown by reference number 232, the server device 202 may input the one or more participant profiles and the sensing information to the generative model (e.g., to cause the generative model to generate a personalized virtual layout for the user associated with the client device 204). For example, the server device 202 may generate the personalized virtual layout within the metaverse collaboration session based on the sensing information and the participant profile by providing the sensing information and the participant profile as an input to the generative model. As shown by reference number 234, the server device 202 may obtain, from the generative model, a personalized virtual layout for the metaverse collaboration session. For example, an output of the generative model may include or indicate the personalized virtual layout (e.g., where the output is based on the input of the one or more participant profiles and the sensing information).

For example, the server device 202 may set a virtual perspective and position for the user for the metaverse collaboration session based on the sensing information, the role, and the mobility type associated with the user. For example, the server device 202 may determine or set the virtual perspective and position (e.g., for an avatar of the user in the metaverse collaboration session) based on available physical space (e.g., as determined using the sensing information) to identify the optimal viewpoint and position for the user within the metaverse collaboration session. The server device 202 may may determine or set the virtual perspective and position by analyzing the sensing information to identify an optimal viewpoint and position, taking into account one or more factors, such as the user’s height, arm reach, available movement space, role, and/or mobility type. The server device 202 may use one or more machine learning models or algorithms to predict the viewpoint and position based on the role, mobility type, and/or past behavior in similar sessions, among other examples, associated with the user.

In some examples, the server device 202 may apply one or more ergonomic and accessibility principles to ensure that the virtual perspective and position are comfortable and accessible for the user in the real world. For example, the server device 202 may determine or set the virtual perspective and position to minimize visual, auditory, and/or motor strain on the user. For example, the server device 202 may adjust the virtual perspective and position to conform to the user’s natural line of sight, such that the visual center of the virtual environment aligns with the user’s gaze direction. Additionally, the server device 202 may determine or set the virtual perspective and position such that visual and auditory elements are presented within a given range of distances, angles, and/or volumes, among other examples, relative to the virtual perspective and position. This may reduce the likelihood of eye strain, headaches, and/or other forms of visual and auditory fatigue for the user. The server device 202 may determine or set the virtual perspective and position relative to one or more control schemes and interactive elements to accommodate the natural motor abilities and limitations of the user. For example, the server device 202 may adjust the sensitivity of virtual controls or provide alternative input methods for users with motor impairments or to accommodate an available movement space of the user.

The server device 202 may determine or set the virtual perspective and position based on the role of the user in the metaverse collaboration session, such as whether the user is a presenter, moderator, or participant, to determine the most suitable viewpoint and position for the role. For instance, a presenter may be positioned at the front of the virtual room, while a participant may be positioned in a seat or at a virtual table. The server device 202 may determine or set the virtual perspective and position based on the mobility type associated with the user, such as whether they are seated, standing, or moving around, to adjust the virtual perspective and position accordingly. For example, if the user is seated, the server device 202 may position them in a virtual chair or at a virtual desk, while if the user is standing, the server device 202 may position the user in a virtual standing area or at a virtual podium.

In some examples, the server device 202 may set an ergonomic position indicated by the one or more ergonomic parameters for the user (e.g., described in connection with FIG. 2A) by adjusting to the virtual chair, desk, or other workspace elements to promote comfortable and healthy working or interacting position for the user. For example, the server device 202 may adjust a height and/or angle of the virtual perspective and position to enable the user to be positioned in the ergonomic position in the real world. As another example, the server device 202 may adjust the position of a virtual display to reduce eye strain and promote good posture for the user. By using biometric and ergonomic information to inform the ergonomic position of the user, the server device 202 can reduce the likelihood of discomfort and injury for the user, and promote overall well-being and productivity.

In some examples, the server device 202 may assign one or more mobility constraints for the user based on the sensing information, the role, and/or the mobility type, among other examples. The one or more mobility constraints may define how, where, and/or if an avatar of the user moves within the personalized virtual layout for the metaverse collaboration session. For example, the server device 202 may determine the available movement space of the user to identify any limitations or constraints on their movement. The server device 202 may also take into account the user's role in the session, such as whether they are a presenter, moderator, or participant, to determine the level of mobility they require. The server device 202 may assign one or more mobility constraints to define how and where an avatar of the user can move in the virtual environment. For example, if the user is a presenter, the server device 202 may assign a mobility constraint that allows the avatar of the user to move freely around the virtual environment, while if the user is a participant, the server device 202 may assign a mobility constraint that restricts a movement of the avatar to a specific area or path. The server device 202 may also consider the mobility type associated with the user, such as whether they are seated, standing, or moving around, to adjust the mobility constraints accordingly. For example, if the user is seated, the server device 202 may assign a mobility constraint that restricts their movement to a specific area or distance from their seat, while if the user is standing or moving around, the server device 202 may assign a mobility constraint that allows the avatar of the user to move more freely.

The one or more mobility constraints may include a movement speed or acceleration constraint, an available area or path in virtual environment in which the avatar of the user can move, one or more rotation or orientation constraints (e.g., indicating an available rotational movement for the avatar), among other examples. By the server device 202 assigning mobility constraints based on the available movement space, role, and mobility type, the server device 202 can ensure that the movement in the virtual environment is comfortable, natural, and intuitive, while also preventing any potential collisions or conflicts with other users or objects in the physical space of the user.

In some examples, the server device 202 may obtain or receive an input from the user indicating a preference for a layout or arrangement of virtual objects. The server device 202 may generate the personalized virtual layout based on the preference. For example, the server device 202 may determine or set the virtual perspective and position based on a preferred position or viewpoint of the user within a metaverse collaboration session.

As shown by reference number 236, the server device 202 may arrange or configure (e.g., for each user participating in the metaverse collaboration session) one or more virtual objects. In some examples, the server device 202 may generate a baseline virtual layout that is common to all users participating in the metaverse collaboration session. For example, the server device 202 may generate the baseline virtual layout based on the participation profiles and the sensing information associated with respective users, as described in more detail elsewhere herein.

For example, the server device 202 may obtain space information indicating available physical spaces for the respective users. The server device 202 may determine a placement of one or more virtual objects based on the one or more roles and the space information. For example, the server device 202 may analyze the space information to identify the most suitable location for each virtual object, taking into account the roles of the users and the physical constraints of movements of respective users. For instance, if a user is a presenter, the server device 202 may determine that a virtual whiteboard or presentation screen should be placed in a prominent location, such as at the front of the room or on a wall. If a user is a participant, the server device 202 may determine that a virtual chair or desk should be placed in a location that allows them to comfortably view the presentation or interact with other users. The server device 202 may also consider other factors when determining the placement of virtual objects, such as the user's preferences, the type of activity or task being performed, and/or the overall aesthetic and atmosphere of the virtual environment. For example, if a user is participating in a virtual meeting, the server device 202 may determine that a virtual table or conference room should be placed in a central location, with virtual chairs and other objects arranged to facilitate communication and collaboration. The placement of virtual objects may also be adjusted in real-time based on changes in the user’s physical space or role. For example, if a user moves to a different location or switches roles, the server device 202 may update the placement of virtual objects to reflect the new situation. By determining the placement of virtual objects based on the role and space information, the server device 202 can create a more immersive and interactive virtual environment that is tailored to the needs and preferences of respective users. This can enhance the user experience and facilitate more effective communication and collaboration with other users.

In some examples, the one or more virtual objects include a reference point that is used for virtual interactions within the metaverse collaboration session. A reference point is a location or object within the virtual environment that serves as a common frame of reference for multiple users. The reference point may be a virtual object, a location, or an avatar. The reference point may be used to facilitate interactions and communication between users within the metaverse collaboration session. For example, a reference point might be a virtual whiteboard, a presentation screen, or a virtual model that multiple users can interact with simultaneously. The server device 202 may synchronize a placement of the reference point among the multiple users based on the one or more roles and the space information. In this context, “synchronizing” refers to ensuring that the reference point is positioned and oriented in the same way for all users, taking into account their individual perspectives and viewpoints. For example, the server device 202 may adjust the placement of the reference point in real-time to ensure that it is consistently located and oriented across all users’ virtual environments, even as avatars of a user move or change viewpoints.

For example, if multiple users are participating in a metaverse collaboration session, the server device 202 may synchronize the placement of a virtual whiteboard or presentation screen to ensure that all users see the same content and can interact with it in the same way. If one user moves the whiteboard or screen, the server device 202 may update the placement of the reference point in real-time to ensure that all users see the new location and can interact with the reference point consistently. By synchronizing the placement of the reference point among multiple users, the server device 202 can create a shared and consistent virtual environment that facilitates effective collaboration and communication among multiple users.

In some examples, the personalized virtual layout may include the baseline virtual layout with one or more personalized virtual object arrangements or configurations. For example, the baseline virtual layout may be a virtual room layout and the personalized virtual layout may include one or more personalized virtual object arrangements within the virtual room for the user. In other examples, the personalized virtual layout may be personalized, or specific to, the user (e.g., each user may have their own personalized virtual layout without a baseline virtual layout).

In some example, the server device 202 may arrange one or more virtual objects (e.g., for the user) based on an ergonomic position for the user that is indicated by the one or more ergonomic parameters described herein. For example, if the one or more ergonomic parameters indicate that the user is sitting in a chair with a specific height and angle, the server device 202 may arrange virtual objects (such as a virtual desk, keyboard, and/or monitor) to be within comfortable reach and view of the user, taking into account the physical characteristics and movement patterns of the user in the real world. The server device 202 may adjust the size, shape, and/or orientation of the virtual objects to fit the ergonomic position of the user, such as by enlarging or reducing a size of a virtual display to reduce eye strain or adjusting the angle of the virtual keyboard to promote comfortable hand and wrist positioning. By arranging virtual objects based on the ergonomic position of the user, the server device 202 can reduce the likelihood of user discomfort and/or fatigue, and promote efficient and effective interaction with the metaverse collaboration session.

As described elsewhere herein, the sensing information may indicate an available movement space within the physical space of the user. The server device 202 may classify one or more virtual objects based on one or more virtual interaction types. A virtual interaction type may indicate how and/or if an avatar of the user can interact with a virtual object in the metaverse collaboration session. The server device 202 may arrange the one or more virtual objects based on the one or more virtual interaction types and the available movement space of the user. For example, a virtual object may be classified as a manipulable object, which can be moved or modified by the avatar, or as a view-only object, which can be viewed but not interacted with by the avatar. In some examples, the server device 202 may classify virtual objects based on interaction types, such as hand-touch, gesture-based, or voice-command, and context-specific relevance. This classification enables the server device 202 to understand how users can interact with each virtual object and how relevant each object is to the current context of the metaverse collaboration session. For example, a virtual whiteboard may be classified as a hand-touch object, while a virtual presentation screen may be classified as a gesture-based object.

The server device 202 may arrange the one or more virtual objects based on the one or more virtual interaction types and the available movement space of the user, taking into account the physical abilities and limitations of the user. For example, if the user has a limited range of motion or is seated in a confined space, the server device 202 may arrange virtual objects in a way that allows the user to interact with them comfortably and without strain. For example, the server device 202 may place manipulable object within reach of the avatar of the user based on the available movement space of the user. In other examples, if the user has a larger available movement space, the server device 202 may arrange virtual objects in a way that takes advantage of the greater mobility and flexibility of the user.

For example, the server device 202 may position or arrange virtual objects within the personalized virtual layout to reflect the role, preferences, and/or physical constraints of the user, using proximity and engagement level as guiding factors. For example, if a participant is a presenter, the server device 202 may position a virtual presentation screen in a prominent location within their environment, such as at the front of the room or on a wall. If a participant is a listener, the server device 202 may position a virtual chair or desk in a location that allows them to comfortably view the presentation screen. By classifying virtual objects based on interaction types and context-specific relevance, and positioning them within each participant's environment to reflect their role, preferences, and physical constraints, the server device 202 can create a more intuitive and user-friendly virtual environment that promotes effective collaboration and communication.

In some examples, the server device 202 generates a personalized virtual layout for each user in a metaverse collaboration session by customizing the room layout based on their role and the collaboration context. For example, if a user is a leader or presenter, the server device 202 may generate a personalized virtual layout that prioritizes central virtual screens, providing the avatar of the user with a prominent location to share information and present to others. In contrast, if a user is an observer or participant, the server device 202 may generate a layout with minimal interaction points, allowing the user to focus on viewing and listening to the presentation without distractions. The server device 202 may also consider the specific collaboration context, such as a meeting, training session, or brainstorming exercise, to determine the most effective layout for each user’s role and responsibilities. By customizing the personalized virtual layout in this way, the server device 202 can facilitate more effective and efficient collaboration, while also enhancing the overall user experience.

As shown by reference number 238, the server device 202 may provide or transmit, and the client device 204 may obtain or receive, a first personalized virtual layout for the metaverse collaboration session. For example, the first personalized virtual layout may be based on the participant profile indicated (e.g., described in connection with reference number 218) and the sensing information (e.g., described in connection with reference number 210 and reference number 220). Additionally, the first personalized virtual layout may be based on participant profiles and sensing information of one or more other users participating in the metaverse collaboration session. The first personalized virtual layout may be generated by the server device 202 as described in connection with reference numbers 226 through 236.

As shown by reference number 240, the client device 204 may display the first personalized virtual layout. For example, the server device 202 may provide the first personalized virtual layout for display by the client device 204. The client device 204 may render the first personalized virtual layout. The client device 204 may use various rendering techniques, such as 2D or 3D graphics rendering, among other examples.

In some aspects, the client device 204 may set, arrange, or configure one or more parameters for the first personalized virtual layout that are specific to the user, such as a lighting parameter, a volume parameter, and/or a brightness parameter, among other examples. For example, the client device 204 may adjust the lighting parameter to optimize the brightness and color temperature of the virtual environment based on the biometric information of the user (e.g., to reduce stress levels, such as if a heart rate of the user satisfies a threshold). The client device 204 may also adjust the volume parameter to ensure that the audio levels are comfortable and suitable for hearing.

As shown by reference number 242, the server device 202 may provide or transmit, and another client device 206 may obtain or receive, a second personalized virtual layout for the metaverse collaboration session. For example, the second personalized virtual layout may be based on a participant profile indicated and sensing information associated with another user of the other client device 206. Additionally, the second personalized virtual layout may be based on participant profiles and sensing information of one or more other users participating in the metaverse collaboration session. The second personalized virtual layout may be generated by the server device 202 as described in connection with reference numbers 226 through 236. In other words, the server device 202 may provide personalized virtual layouts to respective client devices 204 or 206 for respective users participating in the metaverse collaboration session. As shown by reference number 244, the other client device 206 may display the second personalized virtual layout (e.g., in a similar manner as described in connection with reference number 240).

As shown in FIG. 2C, and by reference number 246, the client device 204 may obtain updated sensing information. The updated sensing information may be associated with the physical space 212. In some examples, the peripheral device 214 may periodically scan or image the physical space 212 to obtain the updated sensing information. Additionally, or alternatively, the peripheral device 214 may scan or image the physical space 212 based on detecting an event (such as movement of the user) to obtain the updated sensing information. For example, the updated sensing information may be real-time updated information indicating recent sensing information for the physical space 212. Additionally, or alternatively, the updated sensing information may include updated biometric information of the user. The updated biometric information of the user may include real-time biometric information of the user.

As shown by reference number 248, the client device 204 may transmit or provide, and the server device 202 may receive or obtain, the updated sensing information. As shown by reference number 250, the server device 202 may update the first personalized virtual layout based on the updated sensing information. For example, the server device 202 may adapt the first personalized virtual layout by re-arranging one or more virtual objects based on the updated sensing information. For example, the server device 202 may adjust the presence, position, orientation, and/or size of a virtual object to better align with a new location or interaction type of the user as indicated by the updated sensing information. The server device 202 may add or remove a virtual object based on the updated sensing information, such as adding a new virtual tool or removing a virtual object that is no longer relevant based on the updated sensing information.

The server device 202 may update the first personalized virtual layout in a similar manner as described in connection with reference numbers 226 through 236, but using the updated sensing information rather than the previously provided sensing information. For example, the server device 202 may re-arrange one or more virtual objects in the first personalized virtual layout based on the updated sensing information, taking into a location, orientation, and/or interactions with the virtual environment, among other examples, indicated by the updated sensing information.

In some examples, the server device 202 may update the first personalized virtual layout based on updated biometric information for the user indicating that the user is uncomfortable or stressed. For example, the server device 202 may adjust the first personalized virtual layout to create a more calming or relaxing environment, such as by changing the lighting, color temperature, and/or sound levels, among other examples. Additionally, or alternatively, the server device 202 may adjust the position and/or viewpoint of the user to cause the user to adjust an ergonomic position in the real world to a more comfortable position.

For example, the server device 202 may periodically feed real-time spatial and biometric data into the generative model to adapt a room layout (e.g., the baseline virtual layout), positioning of virtual objects, and/or avatar position or viewpoint arrangements as the physical environment or biometric information for one or more users change. This enables the server device 202 to dynamically adjust the virtual layout(s) based on changing conditions, ensuring that the user’s experience remains optimized and comfortable. For example, if a participant moves to a new location or changes their posture, the server device 202 may adjust the first personalized virtual layout to accommodate the new position or preferences. Similarly, if biometric information for the user indicates a change in their physical or emotional state, the server device 202 can adapt the first personalized virtual layout to promote relaxation or stimulation as needed.

In some examples, the server device 202 may use a feedback loop to adjust layouts based on user interactions and feedback, refining the personalized experience for future sessions. The feedback loop enables the server device 202 (e.g., the generative model) to learn from the behavior and preferences of one or more participants. For example, if a participant consistently interacts with a particular virtual object or feature, the generative model can prioritize a placement and accessibility of the virtual object or feature relative to an avatar of the user in future metaverse collaboration sessions. Similarly, if a user provides feedback on their experience, such as rating their comfort or satisfaction, the generative can use this data to adjust the virtual environment and improve the experience for the user in future sessions. For example, the server device 202 may update the generative model to incorporate the preference of the user for future metaverse collaboration sessions. By feeding data into the generative model and refining the personalized experience through user feedback, the server device 202 can create an adaptive and responsive virtual environment that optimizes the participant’s experience and promotes user well-being.

As shown by reference number 252, the server device 202 may transmit or provide, and the client device 204 may receive or obtain, an updated personalized virtual layout (e.g., as updated by the server device 202 as described in connection with reference number 250). As shown by reference number 254, the client device 204 may display the updated personalized virtual layout for the metaverse collaboration session (e.g., in a similar manner as described in connection with reference number 240).

As a result, the server device 202 may be enabled to dynamically adjust and personalize virtual environments in real-time for a metaverse collaboration session using physical spacing sensing information, biometric information, and role-based information for a given user participating in the metaverse collaboration session. This results in improved performance for the server device 202 because the server device 202 is able to efficiently and effectively manage and render the virtual environment, reducing processing demands and latency. Additionally, the server device 202 may more efficiently and effectively use computer resources, such as processing power, memory, and/or bandwidth, by adapting the virtual environment to the user’s needs and preferences, thereby reducing unnecessary computations and data transmissions for metaverse collaboration session virtual layouts. For example, the server device 202 may provide a more personalized, responsive, and/or immersive experience for a user participating in the metaverse collaboration session, while also improving system performance and efficiency for the server device 202.

As indicated above, FIGS. 2A-2C are provided as an example. Other examples may differ from what is described with regard to FIGS. 2A-2C.

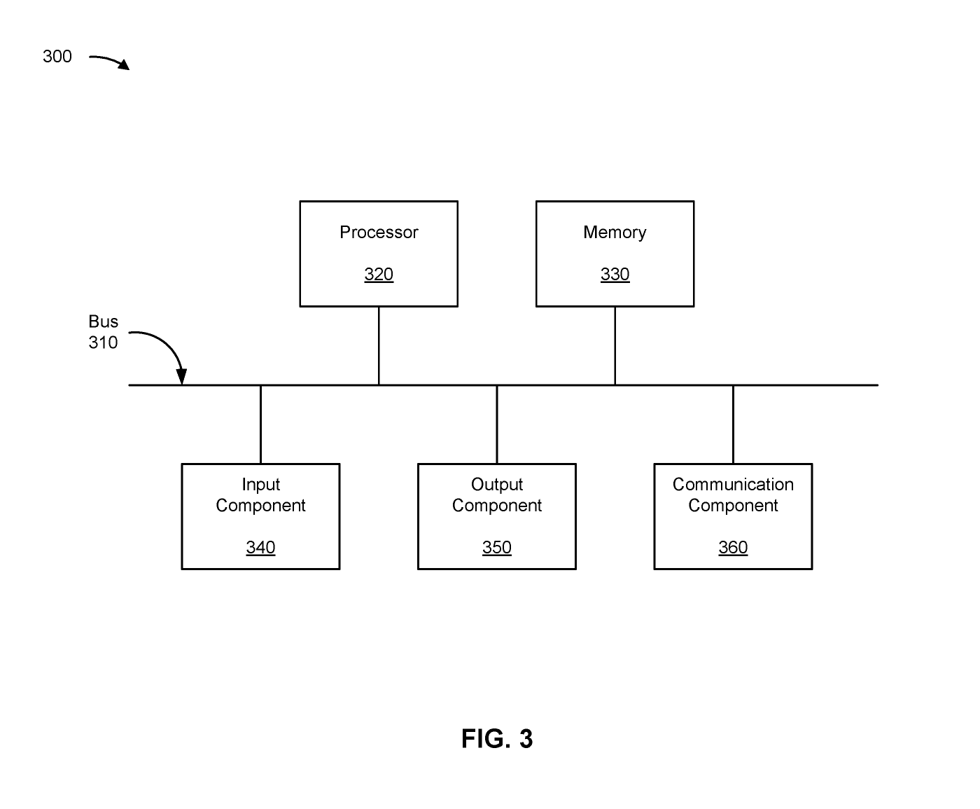

FIG. 3 is a diagram of example components of a device 300 associated with a personalized virtual layout for collaborative metaverse sessions. The device 300 corresponds to one or more of the computer 102, one or more components or devices described in connection with FIG. 1, the server device (e.g., the service device 202), or the client device (e.g., the client device 204 or the other client device(s) 206). In some implementations, the computer 102, one or more components or devices described in connection with FIG. 1, the server device 202, or the client device 204 (or the other client device(s) 206) include one or more devices 300 and/or one or more components of the device 300. In the example shown in FIG. 3, the device 300 includes a bus 310, a processor 320, a memory 330, an input component 340, an output component 350, and/or a communication component 360.

The bus 310 includes one or more components that enable wired and/or wireless communication among the components of the device 300. The bus 310 couples together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 includes a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory, such as RAM, read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). In some implementations, the memory 330 is a non-transitory computer-readable medium. The memory 330 stores information, one or more instructions, and/or software (e.g., one or more software applications) related to the operation of the device 300. In some implementations, the memory 330 includes one or more memories that are coupled (e.g., communicatively coupled) to one or more processors (e.g., processor 320), such as via the bus 310. Communicative coupling between a processor 320 and a memory 330 enables the processor 320 to read and/or process information stored in the memory 330 and/or to store information in the memory 330.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

In some implementations, the device 300 performs one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

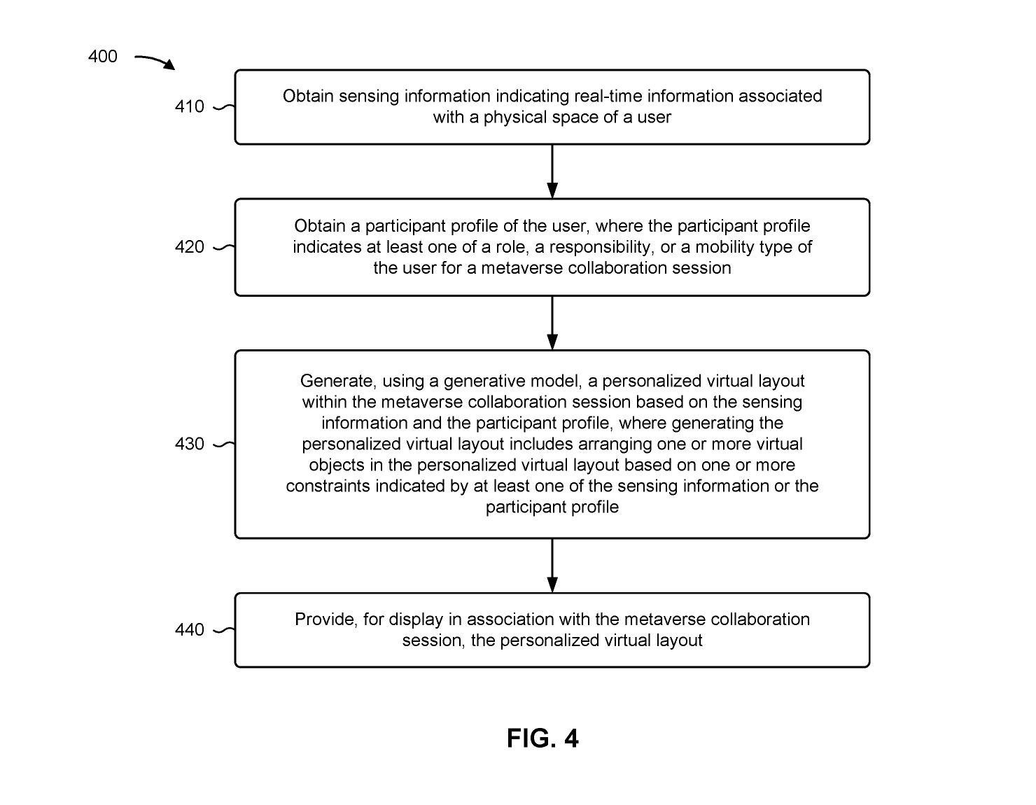

FIG. 4 is a flowchart of an example process 400 associated with a personalized virtual layout for collaborative metaverse sessions. One or more process blocks of FIG. 4 are performed by a server device (e.g., the server device 202, or a computer 102) and/or by another device or a group of devices separate from or including the server device, such as a client device (e.g., the client device 204) or a peripheral device. Additionally, or alternatively, one or more process blocks of FIG. 4 may be performed by one or more components of device 300, such as processor 320, memory 330, input component 340, output component 350, and/or communication component 360.

As shown in FIG. 4, process 400 includes obtaining sensing information indicating real-time information associated with a physical space of a user (block 410). For example, the server device may obtain sensing information indicating real-time information associated with a physical space of a user, as described above.

As further shown in FIG. 4, process 400 includes obtaining a participant profile of the user, where the participant profile indicates at least one of a role, a responsibility, or a mobility type of the user for a metaverse collaboration session (block 420). For example, the server device may obtain a participant profile of the user, where the participant profile indicates at least one of a role, a responsibility, or a mobility type of the user for a metaverse collaboration session, as described above.

As further shown in FIG. 4, process 400 includes generating, using a generative model, a personalized virtual layout within the metaverse collaboration session based on the sensing information and the participant profile, where generating the personalized virtual layout includes arranging one or more virtual objects in the personalized virtual layout based on one or more constraints indicated by at least one of the sensing information or the participant profile (block 430). For example, the server device may generate, using a generative model, a personalized virtual layout within the metaverse collaboration session based on the sensing information and the participant profile, where generating the personalized virtual layout includes arranging one or more virtual objects in the personalized virtual layout based on one or more constraints indicated by at least one of the sensing information or the participant profile, as described above. In some aspects, generating the personalized virtual layout includes arranging one or more virtual objects in the personalized virtual layout based on one or more constraints indicated by at least one of the sensing information or the participant profile.

As further shown in FIG. 4, process 400 includes providing, for display in association with the metaverse collaboration session, the personalized virtual layout (block 440). For example, the server device may provide, for display in association with the metaverse collaboration session, the personalized virtual layout, as described above.

Process 400 may include additional aspects, such as any single aspect or any combination of aspects described below and/or in connection with one or more other processes described elsewhere herein.

In a first aspect, the sensing information indicates an available movement space within the physical space of the user, wherein the one or more constraints include the available movement space, and wherein generating the personalized virtual layout includes classifying the one or more virtual objects based on one or more virtual interaction types, and arranging the one or more virtual objects based on the one or more virtual interaction types and the available movement space.

In a second aspect, alone or in combination with the first aspect, the metaverse collaboration session is associated with multiple users including the user, and process 400 includes obtaining participant profiles of respective users, from the multiple users, to obtain role information indicating one or more roles associated with the respective users for the metaverse collaboration session, and obtaining space information indicating available physical spaces for the respective users, and wherein generating the personalized virtual layout includes determining a placement of the one or more virtual objects based on the one or more roles and the space information.

In a third aspect, alone or in combination with one or more of the first and second aspects, the one or more virtual objects include a reference point that is used for virtual interactions within the metaverse collaboration session, and wherein generating the personalized virtual layout includes synchronizing a placement of the reference point among the multiple users based on the one or more roles and the space information.

In a fourth aspect, alone or in combination with one or more of the first through third aspects, process 400 includes obtaining updated sensing information indicating updated real-time information associated with the physical space of the user, and adapting the personalized virtual layout by re-arranging at least one of the one or more virtual objects based on the updated sensing information.

In a fifth aspect, alone or in combination with one or more of the first through fourth aspects, generating the personalized virtual layout includes setting a virtual perspective and position for the user for the metaverse collaboration session based on the sensing information, the role, and the mobility type.

In a sixth aspect, alone or in combination with one or more of the first through fifth aspects, generating the personalized virtual layout includes assigning one or more mobility constraints for the user based on the sensing information, the role, and the mobility type.

In a seventh aspect, alone or in combination with one or more of the first through sixth aspects, the sensing information includes biometric information for the user indicating one or more ergonomic parameters associated with the user, and wherein generating the personalized virtual layout includes arranging at least one of the one or more virtual objects based on an ergonomic position for the user that is indicated by the one or more ergonomic parameters.

In an eighth aspect, alone or in combination with one or more of the first through seventh aspects, the sensing information includes one or more of spatial data, depth-sensing data, biometric data, or wearable device data.

In a ninth aspect, alone or in combination with one or more of the first through eighth aspects, the generative model is a generative adversarial network model.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
obtaining sensing information indicating real-time information associated with a physical space of a user;
obtaining a participant profile of the user, wherein the participant profile indicates at least one of a role, a responsibility, or a mobility type of the user for a metaverse collaboration session;
generating, using a generative model, a personalized virtual layout within the metaverse collaboration session based on the sensing information and the participant profile,
wherein generating the personalized virtual layout includes arranging one or more virtual objects in the personalized virtual layout based on one or more constraints indicated by at least one of the sensing information or the participant profile; and
providing, for display in association with the metaverse collaboration session, the personalized virtual layout.

2. The method of claim 1, wherein the sensing information indicates an available movement space within the physical space of the user, wherein the one or more constraints include the available movement space, and wherein generating the personalized virtual layout comprises:
classifying the one or more virtual objects based on one or more virtual interaction types; and
arranging the one or more virtual objects based on the one or more virtual interaction types and the available movement space.

3. The method of claim 1, wherein the metaverse collaboration session is associated with multiple users including the user, the method further comprising:
obtaining participant profiles of respective users, from the multiple users, to obtain role information indicating one or more roles associated with the respective users for the metaverse collaboration session; and
obtaining space information indicating available physical spaces for the respective users, and
wherein generating the personalized virtual layout comprises:
determining a placement of the one or more virtual objects based on the one or more roles and the space information.

4. The method of claim 3, wherein the one or more virtual objects include a reference point that is used for virtual interactions within the metaverse collaboration session, and
wherein generating the personalized virtual layout comprises:
synchronizing a placement of the reference point among the multiple users based on the one or more roles and the space information.

5. The method of claim 1, further comprising:
obtaining updated sensing information indicating updated real-time information associated with the physical space of the user; and
adapting the personalized virtual layout by re-arranging at least one of the one or more virtual objects based on the updated sensing information.

6. The method of claim 1, wherein generating the personalized virtual layout comprises:
setting a virtual perspective and position for the user for the metaverse collaboration session based on the sensing information, the role, and the mobility type.

7. The method of claim 1, wherein generating the personalized virtual layout comprises:
assigning one or more mobility constraints for the user based on the sensing information, the role, and the mobility type.

8. The method of claim 1, wherein the sensing information includes biometric information for the user indicating one or more ergonomic parameters associated with the user, and wherein generating the personalized virtual layout comprises:
arranging at least one of the one or more virtual objects based on an ergonomic position for the user that is indicated by the one or more ergonomic parameters.

9. The method of claim 1, wherein the sensing information includes one or more of spatial data, depth-sensing data, biometric data, or wearable device data.

10. The method of claim 1, wherein the generative model is a generative adversarial network model.

11. A computer system, comprising:
a processor set;
one or more computer-readable storage media; and
program instructions stored on the one or more computer-readable storage media to cause the processor set to perform operations comprising:
obtaining sensing information indicating real-time information associated with a physical space of a user;
obtaining a participant profile of the user, wherein the participant profile indicates at least one of a role, a responsibility, or a mobility type of the user for a metaverse collaboration session;
generating, using a generative model, a personalized virtual layout within the metaverse collaboration session based on the sensing information and the participant profile, wherein the personalized virtual layout includes one or more virtual objects that are configured based on one or more constraints indicated by at least one of the sensing information or the participant profile; and
providing, for display in association with the metaverse collaboration session, the personalized virtual layout.

12. The computer system of claim 11, wherein the generative model includes a generative adversarial network that includes a generator network model and a discriminator network model, wherein the generator network model is configured to generate the personalized virtual layout, and wherein the discriminator network model is configured to refine the personalized virtual layout.

13. The computer system of claim 11, wherein the generative model is trained using historical metaverse layouts, user interaction data, and historical participation profiles to generate a dataset of metaverse collaboration scenarios, and
wherein generating the personalized virtual layout comprises:
identifying a metaverse collaboration scenario from the metaverse collaboration scenarios based on a session type of the metaverse collaboration session and the participant profile; and
generating the personalized virtual layout based on the generative model using data, from the dataset, that corresponds to the metaverse collaboration scenario.

14. The computer system of claim 11, wherein the operations further comprise:
obtaining updated sensing information indicating updated real-time information for the user and the physical space; and
adapting a position of a virtual object, of the one or more virtual objects, based on the real-time updated sensing information.

15. The computer system of claim 11, wherein the sensing information indicates an available movement space within the physical space of the user, wherein the one or more constraints include the available movement space, and wherein generating the personalized virtual layout comprises:
classifying the one or more virtual objects based on one or more virtual interaction types; and
arranging the one or more virtual objects based on the one or more virtual interaction types and the available movement space.

16. The computer system of claim 11, wherein the metaverse collaboration session is associated with multiple users including the user, and wherein the operations further comprise:
obtaining participant profiles of respective users, from the multiple users, to obtain role information indicating one or more roles associated with the respective users for the metaverse collaboration session; and
obtaining space information indicating available physical spaces for the respective users, and
wherein generating the personalized virtual layout comprises:
determining a placement of the one or more virtual objects based on the one or more roles and the space information.

17. The computer system of claim 16, wherein the one or more virtual objects include a reference point that is used for virtual interactions within the metaverse collaboration session, and
wherein generating the personalized virtual layout comprises:
synchronizing a placement of the reference point among the multiple users based on the one or more roles and the space information.

18. A computer program product comprising:
one or more computer-readable storage media; and
program instructions stored on the one or more computer-readable storage media to perform operations comprising:
obtaining sensing information indicating real-time information associated with a physical space of a user;
obtaining a participant profile of the user, wherein the participant profile indicates at least one of a role, a responsibility, or a mobility type of the user for a metaverse collaboration session;
generating, using a generative model, a personalized virtual layout within the metaverse collaboration session based on the sensing information and the participant profile;
arranging, using the generative model, one or more virtual objects within the personalized virtual layout to accommodate real-time movements of the user; and
providing, for display in association with the metaverse collaboration session, the personalized virtual layout.

19. The computer program product of claim 18, wherein the operations further comprise:
analyzing real-time biometric data from the user to identify a physical or mental state of the user; and
adjusting, based on the analysis, one or more aspects of the personalized virtual layout.

20. The computer program product of claim 18, wherein the operations further comprise:
receiving input from the user indicating a preference for a layout or arrangement of virtual objects; and
updating the generative model to incorporate the preference for future metaverse collaboration sessions.
